(19) United States
(12) Patent Application Publication
(10) Pub. No.: US 2026/0087809 A1
(43) Pub. Date: Mar. 26, 2026

(54) APPARATUS AND METHOD FOR CALCULATING DANCE BATTLE SCORE WHICH EVALUATE DANCE BATTLE AND CALCULATE INTEGRATED SCORE

(71) Applicant: Sidewalk Entertainment Inc., Seoul (KR)

(72) Inventors: Ki Bong KOOK, Goyang-si (KR); Kyung Heun KIM, Seoul (KR); Ju Won KO, Seoul (KR); Tae Hoon KIM, Incheon (KR)

(21) Appl. No.: 19/324,715

(22) Filed: Sep. 10, 2025

(30) Foreign Application Priority Data
Sep. 24, 2024 (KR) 10-2024-0129325
Nov. 19, 2024 (KR) 10-2024-0164824

(51) Int. Cl. G06V 20/40; A63B 71/06; G06V 40/20

(52) U.S. Cl. CPC G06V 20/42; A63B 71/0605; G06V 40/23; A63B 2071/0677

(57) ABSTRACT

Disclosed are an apparatus and method for calculating a dance battle score which evaluate a dance battle and calculate an integrated score. The apparatus includes a storage unit configured to store at least one judge persona, a communication unit configured to receive dance video data, and a processor configured to generate the at least one judge persona, analyze the dance video data using the at least one judge persona, and perform processing to evaluate at least one of a technical element or an artistic element of a dance.

### CROSS REFERENCE TO RELATED APPLICATION

The present application claims priority to Korean Patent Application Nos. 10-2024-0129325 and 10-2024-0164824, filed Sep. 24, 2024 and Nov. 19, 2024 respectively, the entire contents of which are incorporated herein for all purposes by this reference.

### BACKGROUND

### Field of the Invention

The present invention relates to an apparatus and method for calculating a dance battle score, and more particularly to an apparatus and method for calculating a dance battle score which evaluate a dance battle in terms of an artistic element in addition to a technical element using artificial intelligence (AI), and calculate an integrated score obtained by integrating scores computed using various methods.

### Description of the Related Art

Recently, street dance has gained significant popularity due to the frequent appearance of dance battles where dancers take turns competing in dance skills across various media platforms. Dance battles have become a new cultural phenomenon worldwide, and breakdancing has been recognized as an official Olympic event and has been adopted as a demonstration sport at the National Sports Festival, gaining popularity as a sport.

In traditional dance battles, evaluation has been performed focusing mainly on technical accuracy or movement difficulty, failing to fully reflect non-quantitative factors such as artistry and creativity in many cases. Due to such a problem, apart from being excellent at dancing, even world-class dancers have been eliminated depending on the tendencies of judges. Furthermore, due to an evaluation method failing to fully reflect artistry and individuality, which are the essence of dance battles, the satisfaction of both participants and audiences has been lowered.

### SUMMARY

Therefore, it is an object of the present invention to provide an apparatus and method for calculating a dance battle score, which evaluate a dance battle and calculate an integrated score, capable of fairly evaluating both a technical element and an artistic element of the dance battle and calculating the integrated score.

In accordance with an aspect of the present invention, the above and other objects can be accomplished by the provision of an apparatus for evaluating a dance battle score including a storage unit configured to store at least one judge persona generated to evaluate a dance battle, a communication unit configured to receive dance video data generated by capturing the dance battle, and a processor configured to generate the at least one judge persona according to judge information, analyze the dance video data using the at least one judge persona, and perform processing to evaluate at least one of a technical element or an artistic element of a dance.

The processor may include a persona generation unit configured to generate at least one judge persona having a unique background, areas of expertise, and evaluation criteria in a JSON (JavaScript Object Notation) format based on the judge information, a dance evaluation unit configured to analyze the dance video data and evaluate the artistic element and the technical element using the at least one judge persona, and a score calculation unit configured to sum results of evaluation by the at least one judge persona.

The dance evaluation unit may evaluate the artistic element by evaluating movement of a dancer based on a feature keyword included in the judge information using an artificial intelligence (AI)-based Multi Modal AI.

The storage unit may further store evaluation criteria movement data, and the dance evaluation unit may evaluate the technical element by determining similarity with the evaluation criteria movement data using the at least one judge persona after extracting movement metadata from the dance video data.

In accordance with another aspect of the present invention, there is provided a method of calculating a dance battle score by a dance battle score calculation apparatus configured to evaluate a dance battle and calculate a score, the method including inputting judge information for evaluating the dance battle to the dance battle score calculation apparatus, generating, by the dance battle score calculation apparatus, at least one judge persona for evaluating the dance battle according to the judge information, receiving, by the dance battle score calculation apparatus, dance video data captured through a predetermined external terminal device communicating with the dance battle score calculation apparatus, evaluating, by the dance battle score calculation apparatus, at least one of a technical element or an artistic element of a dance by analyzing the dance video data using the at least one judge persona, and transmitting, to the external terminal device, a final score obtained by summing results of evaluation by the at least one judge persona together with evaluation information.

The generating may include generating the at least one judge persona having a unique background, areas of expertise, and evaluation criteria in a JSON format based on the judge information.

The evaluating may include evaluating the artistic element by evaluating movement of a dancer based on a feature keyword included in the judge information using an AI-based Multi Modal AI.

The evaluating may include evaluating the technical element by determining similarity with evaluation criteria movement data using the at least one judge persona after extracting movement metadata from the dance video data.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a schematic configuration of a dance battle score calculation apparatus according to an embodiment of the present invention;

FIG. 2 is a block diagram schematically illustrating a configuration of a processor included in the dance battle score calculation apparatus according to an embodiment of the present invention;

FIGS. 3 and 4 are diagrams for describing a method of generating a judge persona by the dance battle score calculation apparatus according to an embodiment of the present invention;

FIGS. 5, 6 and 7 are diagrams for describing a method of evaluating a dance by the dance battle score calculation apparatus according to an embodiment of the present invention; and

FIG. 8 is a flowchart for describing a method of calculating a dance battle score according to an embodiment of the present invention.

### DETAILED DESCRIPTION OF EXEMPLARY EMBODIMENTS

Hereinafter, a detailed description will be given of an apparatus and method for calculating a dance battle score which evaluate a dance battle and calculate an integrated score (hereinafter, a dance battle score calculation apparatus and a method of calculating a dance battle score) according to a preferred embodiment of the present invention with reference to the accompanying drawings.

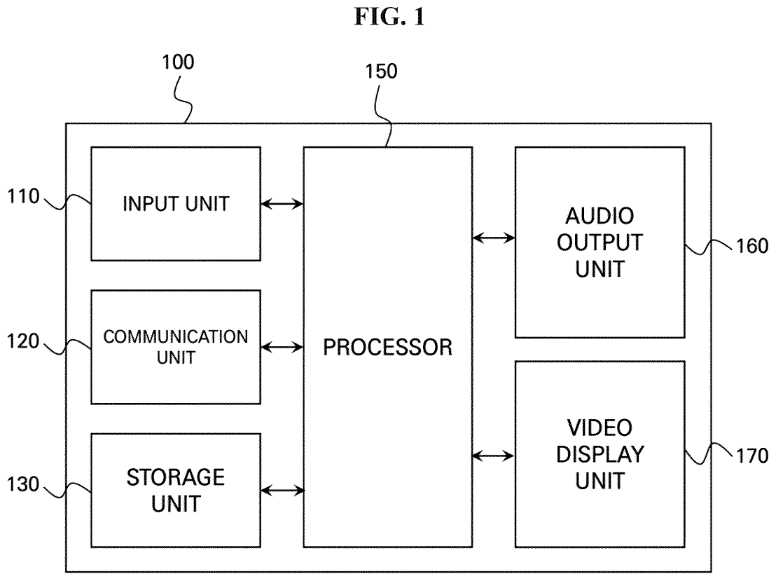

FIG. 1 is a block diagram illustrating a schematic configuration of the dance battle score calculation apparatus according to an embodiment of the present invention.

Referring to FIG. 1, the dance battle score calculation apparatus 100 of the present invention includes an input unit 110, a communication unit 120, a storage unit 130, an audio output unit 160, a video display unit 170, and a processor 150. Each component may be integrated, added, or omitted depending on the specifications of the dance battle score calculation apparatus 100 actually implemented. That is, two or more components may be combined into one component, or one component may be subdivided into two or more components, as needed. In addition, a function performed by each block is intended to describe the embodiment of the present disclosure, and a specific operation or device thereof does not limit the scope of the present invention.

In the present invention, the dance battle score calculation apparatus 100 refers to a server, but is not limited thereto. The apparatus may refer to a fixed device such as a desktop computer or a mobile device such as a smartphone, a tablet, or a notebook, and may be used in a comprehensive sense unless mentioned otherwise. Here, the server refers to a device or system that transmits data to or receives data from various types of user terminals, i.e., clients.

The input unit 110 is a user interface implemented as a key, a touch-sensitive screen, or mouse to receive a user instruction. Judge information for generating a judge persona that evaluates a dance battle is input through the input unit 110. The judge information is used to generate a virtual judge persona having various characteristics and areas of expertise, and the judge information includes information such as name, age, areas of expertise, and evaluation criteria. Furthermore, an instruction for modifying the judge persona may be input through the input unit 110 according to the needs of a dance battle organizer, thereby changing criteria for determining a dance battle score.

The communication unit 120 may include one or more modules that enable wired or wireless communication between the dance battle score calculation apparatus 100 and a wired or wireless network, between the dance battle score calculation apparatus 100 and another device, or between the dance battle score calculation apparatus 100 and an external server. In addition, the communication unit 120 may include one or more modules that connect the dance battle score calculation apparatus 100 to one or more networks. Furthermore, the communication unit 120 refers to a module for wired/wireless network access, which may be built into or externally mounted on the dance battle score calculation apparatus 100 and configured to transmit and receive wired/wireless signals.

In the present invention, the communication unit 120 communicates with an external terminal device (not shown) equipped with a photographing function via a wired/wireless network, thereby receiving dance video data captured and transmitted by the external terminal device. Furthermore, viewer scores input by viewers who viewed the dance battle through external terminal devices, such as smartphones, are received through the communication unit 120. Furthermore, the dance battle score and the judge information calculated by the dance battle score calculation apparatus 100 are transmitted to the external terminal device.

The storage unit 130 may store data supporting various functions of the dance battle score calculation apparatus 100. That is, the storage unit 130 may store a plurality of application programs executed on the dance battle score calculation apparatus 100, and data, instructions, and at least one program instruction for an operation of the dance battle score calculation apparatus 100. At least some of these application programs may be present on the dance battle score calculation apparatus 100 from the time of shipment for basic functions of the apparatus 100, or may be downloaded from an external server via wireless communication.

Furthermore, the storage unit 130 stores a judge persona generated in a JSON (JavaScript Object Notation) format by the processor 150 described below. At least one judge persona having a unique background, areas of expertise, and evaluation criteria is stored in the storage unit 130 in a database form. Furthermore, the storage unit 130 stores evaluation criteria movement data, which serves as a criterion for evaluating a technical element of a dance. The evaluation criteria movement data is data generated by AI capable of generating movement according to dance difficulty, and the data is generated by the external terminal device and received through the communication unit 120 or generated by the processor 150 described below.

The audio output unit 160 outputs audio data related to functions performed by the dance battle score calculation apparatus 100. In the present invention, the audio output unit 160 outputs audio data when dance video data received through the communication unit 120 or stored in the storage unit 130 is played.

The video display unit 170 displays information or video data processed by the dance battle score calculation apparatus 100. For example, the video display unit 170 displays execution screen information of an application program executed on the dance battle score calculation apparatus 100 or information on a user interface (UI) or a graphical user interface (GUI) according to the execution screen information. In the present invention, the video display unit 170 displays video when dance video data received through the communication unit 120 or stored in the storage unit 130 is played. The video display unit 170 may be implemented in combination with a touch-type user interface.

The processor 150 may control the overall operation of the dance battle score calculation apparatus 100, and may provide or process appropriate information or functions by processing signals, data, information, etc. input or output through components of the dance battle score calculation apparatus 100 or by operating application programs stored in the storage unit 130. In addition, the processor 150 may control at least some of the components of the dance battle score calculation apparatus 100 to execute the application program stored in the storage unit 130. Furthermore, the processor 150 may combine and operate at least two of the components included in the dance battle score calculation apparatus 100 to execute the application program.

In the present invention, the processor 150 generates a judge persona in the JSON format based on judge information input through the input unit 110 or received through the communication unit 120 and stores the judge persona in the storage unit 130. Further, the processor fetches the judge persona required for evaluation during a dance battle from the storage unit 130 and analyzes the dance video data received through the communication unit 120. In this instance, the processor 150 performs processing to evaluate not only the technical element but also the artistic element of the dance based on the judge persona.

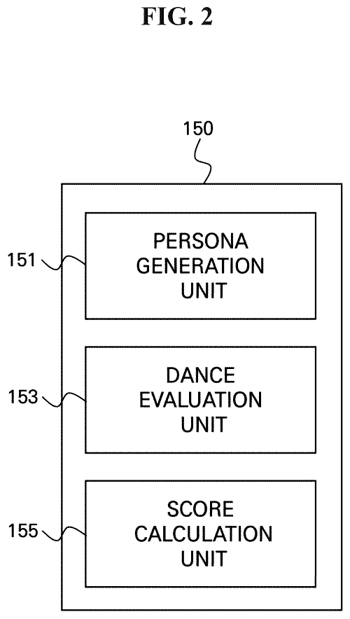

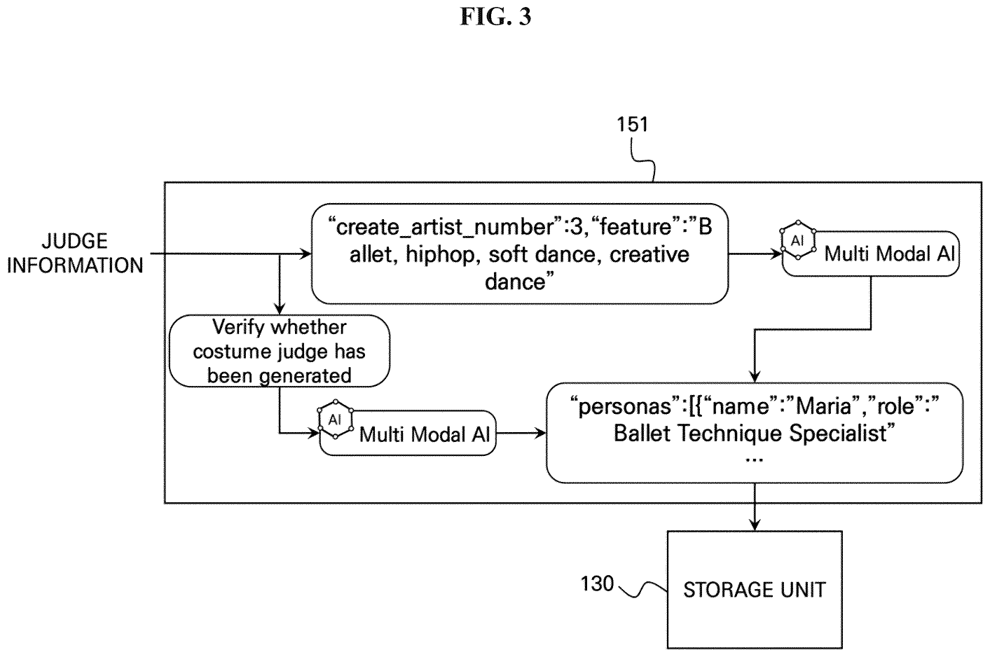

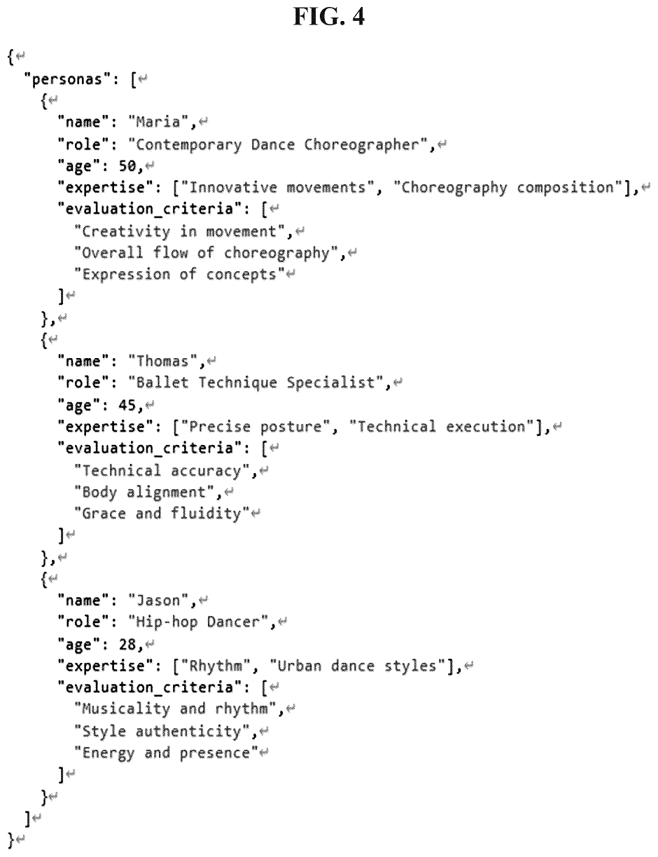

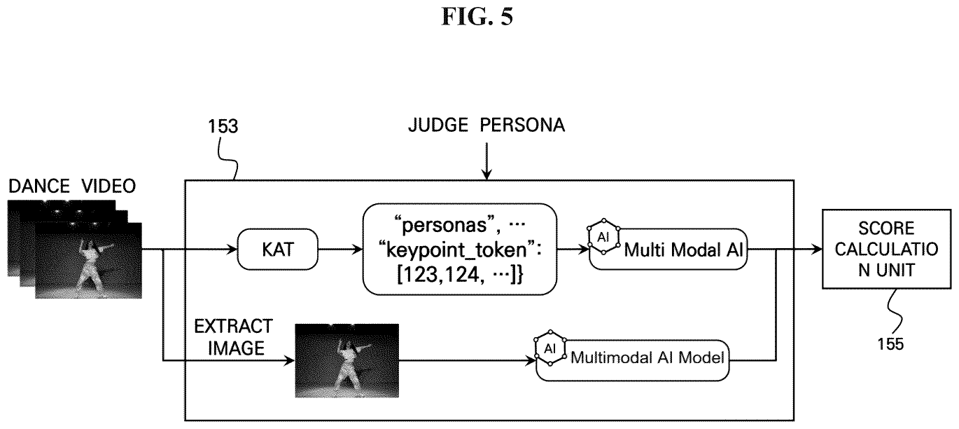

FIG. 2 is a block diagram schematically illustrating a configuration of the processor included in the dance battle score calculation apparatus according to an embodiment of the present invention, FIGS. 3 and 4 are diagrams for describing a method of generating a judge persona by the dance battle score calculation apparatus according to an embodiment of the present invention, and FIGS. 5 to 7 are diagrams for describing a method of evaluating a dance by the dance battle score calculation apparatus according to an embodiment of the present invention.

Referring to FIG. 2, the processor 150 includes a persona generation unit 151, a dance evaluation unit 153, and a score calculation unit 155.

The persona generation unit 151 generates at least one judge persona having a unique background, areas of expertise, and evaluation criteria in the JSON format based on the judge information. Referring to FIG. 3, for example, the persona generation unit 151 inputs the judge information to an AI-based Multi Modal AI, generates a judge persona in the JSON format, and stores the judge persona in the storage unit 130. That is, when the judge information is input to the AI-based Multi Modal AI in a format “create_artist_number”:3, “feature”: “Ballet, hip-hop, soft dance, creative dance,” the judge information is output as code in the JSON formant as illustrated in FIG. 4 and stored in the storage unit 130. The judge persona generated in this manner analyzes movement of a dancer based on a feature keyword using the AI-based Multi Modal AI, and evaluates the artistic element.

Names of judge personas illustrated in FIG. 4 are “Maria,” “Thomas,” and “Jason.” Maria is a 50-year-old contemporary dance choreographer who specializes in innovative movements and choreographic composition and considers creativity, an overall flow of the choreography, and expression of concepts as evaluation criteria. Thomas is a 45-year-old ballet technique specialist who specializes in precise posture and technical execution and considers technical accuracy, body alignment, grace, and fluidity as evaluation criteria. In addition, Jason is a 28-year-old hip-hop dancer who specializes in rhythm and urban dance styles and considers musicality, rhythm, style authenticity, energy, and presence as evaluation criteria.

Meanwhile, when the judge information includes information related to generation of a judge who evaluates costumes of dancers, the persona generation unit 151 also generates a judge persona who evaluates the costumes using the AI-based Multi Modal AI. The judge persona who evaluates the costumes uses a multimodal AI model to analyze the costumes in priority based on a feature keyword, thereby evaluating the artistic element.

Meanwhile, when the judge information input through the input unit 110 changes according to the needs of the dance battle organizer, the persona generation unit 151 generates a new judge persona based on the changed judge information. For example, the organizer may generate a judge persona using a prompt illustrated in [Table 1] below to reflect the needs of an apparel advertiser.

TABLE 1

| Question | Sample answer |
|---|---|
| “You are a judge who evaluates whether | The mood created by the red top and the |
| the dance and the costume match. Please | passionate dance really go well |
| look at the image and give your opinion | together./88 |
| and score (out of 100). Your answer | |
| should be as follows.” | |
| {Opinion}/{Score} | |
| “You are a musical star. You are | The dance was reminiscent of the cat |
| sensitive to the latest trends and love | movements in the musical Cats. |
| unique ideas. Please watch the dance and | However, it seemed a bit out of style./65 |
| give your opinion and score (out of 100). | |
| Your answer should be as follows.” | |
| {Opinion}/{Score} | |

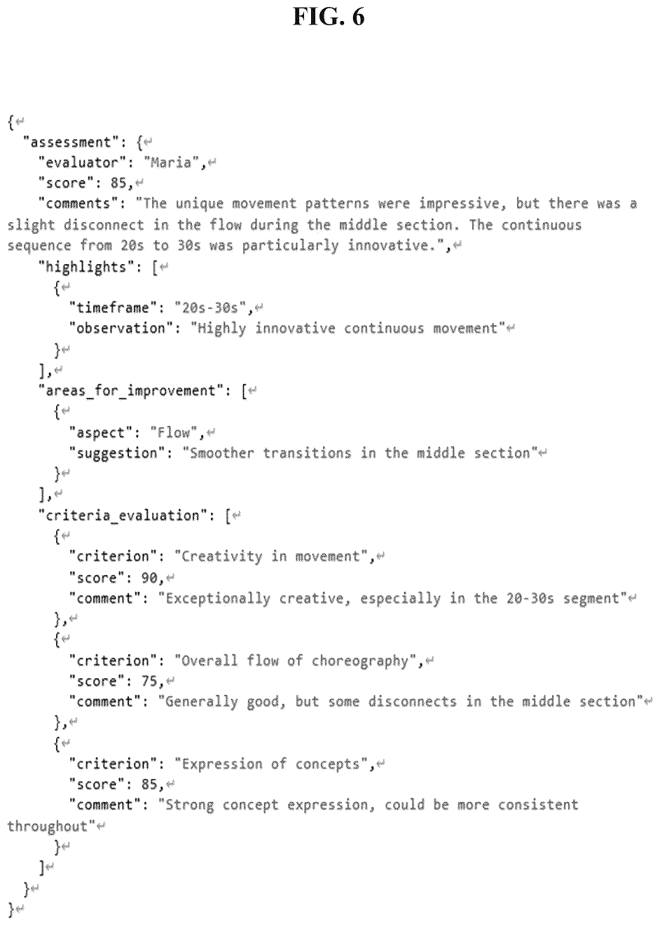

The dance evaluation unit 153 analyzes dance video data and evaluates an artistic element and a technical element using a judge persona stored in the storage unit 130. A method of evaluating the artistic element will be described with reference to FIG. 5. The dance evaluation unit 153 analyzes movements of the dancer using a keypoint action token (KAT), which converts a movement sequence into a token sequence, to extract a video keypoint. Then, the judge persona is used to analyze a keypoint token for each sequence, thereby outputting an artistic evaluation score and feedback obtained by evaluating the dance movements. In this instance, as illustrated in FIG. 6, evaluation scores and feedback of all judge personas for evaluating the dance battle are output, and evaluation scores and feedback for each movement and sequence are output.

Furthermore, the dance evaluation unit 153 outputs an artistic evaluation score and feedback obtained by evaluating a costume of a dancer using a judge persona who extracts an image of the dancer from the dance video data and evaluates the costume. For example, in a dance battle, a degree to which costumes of two participants match the music is represented as 49% for participant A and 51% for participant B.

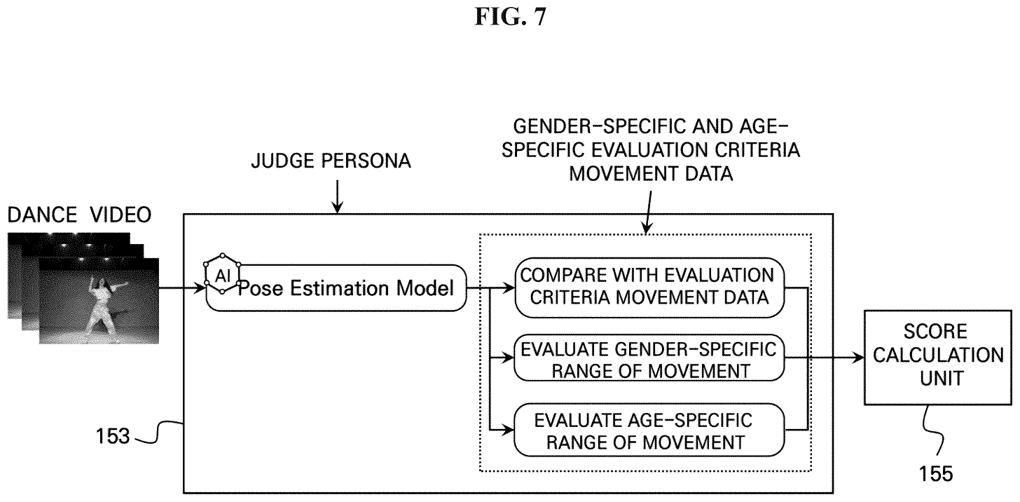

A method of evaluating the technical element will be described with reference to FIG. 7. The dance evaluation unit 153 inputs dance video data to an AI-based pose calculation model to extract movement metadata, and then evaluates accuracy of movement by determining similarity with evaluation criteria movement data stored in the storage unit 130 using a judge persona. In this instance, the dance evaluation unit 153 evaluates a gender-specific range of movement and an age-specific range of movement with reference to gender-specific information and age-specific information of dance battle participants. Here, the dance evaluation unit 153 may award bonus points to older participants or award higher scores to older participants during a movement accuracy evaluating process. The gender-specific information and the age-specific information of the dance battle participants are input through the input unit 110 or transmitted from an external device through the communication unit 120 and stored in the storage unit 130.

The score calculation unit 155 sums and outputs results of evaluation by the judge personas. In more detail, in response to the dance evaluation unit 153 outputting a result of evaluating the artistic element and the technical element by the at least one judge persona, the score calculation unit 155 sums and outputs total scores awarded by all judge personas. In this instance, the score calculation unit 155 may sum algorithmic evaluation scores according to setting of the dance battle organizer, or may sum viewer scores received through the communication unit 120. A participant having a highest final score, which is obtained by summing all scores, wins, and the final score and the evaluation information are transmitted to an external terminal device belonging to the participant through the communication unit 120.

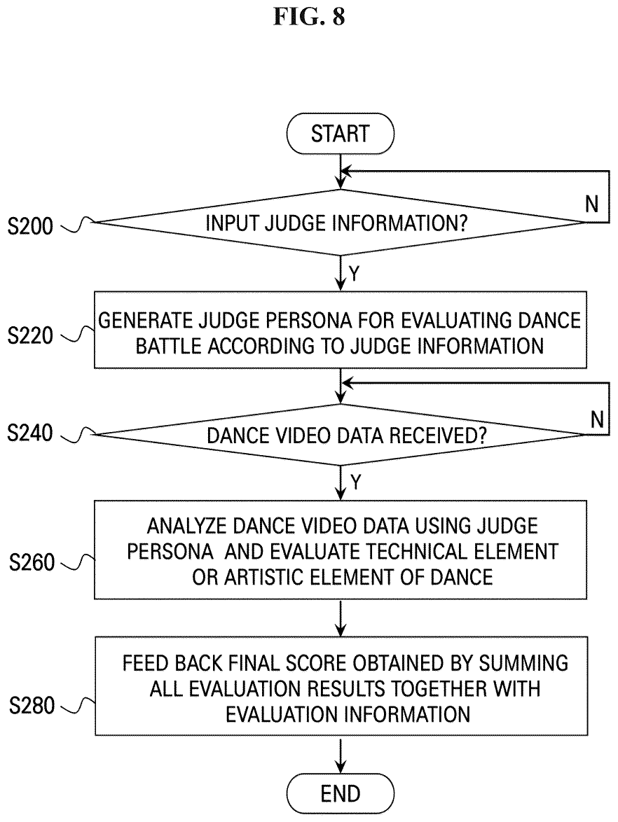

FIG. 8 is a flowchart for describing a method of calculating a dance battle score according to an embodiment of the present invention.

According to FIG. 8, first, in response to judge information for evaluating a dance battle being input to the dance battle score calculation apparatus 100 (S200-Y), at least one judge persona for evaluating the dance battle is generated in the dance battle score calculation apparatus 100 according to the judge information. The judge information is information for generating a virtual judge persona having various characteristics and areas of expertise, and the judge information includes information such as name, age, areas of expertise, and evaluation criteria. The dance battle score calculation apparatus 100 inputs the judge information to the AI-based Multi Modal AI to generate a judge persona in the JSON format having a unique background, areas of expertise, and evaluation criteria.

In response to dance video data captured through the external terminal device communicating with the dance battle score calculation apparatus 100 being received by the dance battle score calculation apparatus 100 (S240-Y), the dance video data is analyzed using at least one judge persona, and a technical element or an artistic element of a dance is evaluated by the dance battle score calculation apparatus 100 (S260).

The dance battle score calculation apparatus 100 evaluates the artistic element by evaluating movement of a dancer based on a feature keyword included in the judge information using the AI-based Multi Modal AI. In addition, the artistic element may be further evaluated by evaluating a costume of the dancer based on a feature keyword included in the judge information using the multimodal AI model. Furthermore, after extracting movement metadata from the dance video data, the technical element is evaluated by determining similarity with evaluation criteria movement data using at least one judge persona.

The dance battle score calculation apparatus 100 feeds back a final score obtained by summing all results of evaluation by the at least one judge persona together with the evaluation information (S80). In other words, a result of evaluating the artistic element based on movement evaluation and costume evaluation and a result of evaluating the technical element are summed, and the evaluation information and a final score obtained by summing algorithmic evaluation scores or viewer scores are transmitted to the external terminal device.

Through the above process, it is possible to comprehensively evaluate not only technical accuracy of dance battle participants, but also artistic elements such as creativity, expressiveness, and stage presence.

Using the apparatus and method for calculating a dance battle score which evaluate a dance battle and calculate an integrated score, it is possible to comprehensively evaluate not only technical accuracy of dance battle participants, but also artistic elements such as creativity, expressiveness, and stage presence.

In addition, by extending evaluation criteria of a dance battle as needed or introducing various evaluation criteria, it is possible to fairly evaluate individuality and artistic expressions of participants.

Further, accurate feedback may be provided to participants based on evaluating results, so that the participants may clearly recognize technical shortcomings and points for improvement.

What is claimed is:

1. An apparatus for calculating a dance battle score, the apparatus comprising:
a storage unit configured to store at least one judge persona generated to evaluate a dance battle;
a communication unit configured to receive dance video data generated by capturing the dance battle; and
a processor configured to generate the at least one judge persona according to judge information, analyze the dance video data using the at least one judge persona, and perform processing to evaluate at least one of a technical element or an artistic element of a dance.

2. The apparatus according to claim 1, wherein the processor comprises:
a persona generation unit configured to generate at least one judge persona having a unique background, areas of expertise, and evaluation criteria in a JSON (JavaScript Object Notation) format based on the judge information;
a dance evaluation unit configured to analyze the dance video data and evaluate the artistic element and the technical element using the at least one judge persona; and
a score calculation unit configured to sum results of evaluation by the at least one judge persona.

3. The apparatus according to claim 2, wherein the dance evaluation unit evaluates the artistic element by evaluating movement of a dancer based on a feature keyword included in the judge information using an artificial intelligence (AI)-based Multi Modal AI.

4. The apparatus according to claim 2, wherein:
the storage unit further stores evaluation criteria movement data, and
the dance evaluation unit evaluates the technical element by determining similarity with the evaluation criteria movement data using the at least one judge persona after extracting movement metadata from the dance video data.

5. A method of calculating a dance battle score by a dance battle score calculation apparatus configured to evaluate a dance battle and calculate a score, the method comprising:
inputting judge information for evaluating the dance battle to the dance battle score calculation apparatus;
generating, by the dance battle score calculation apparatus, at least one judge persona for evaluating the dance battle according to the judge information;
receiving, by the dance battle score calculation apparatus, dance video data captured through a predetermined external terminal device communicating with the dance battle score calculation apparatus;
evaluating, by the dance battle score calculation apparatus, at least one of a technical element or an artistic element of a dance by analyzing the dance video data using the at least one judge persona; and
transmitting, to the external terminal device, a final score obtained by summing results of evaluation by the at least one judge persona together with evaluation information.

6. The method according to claim 5, wherein the generating comprises generating the at least one judge persona having a unique background, areas of expertise, and evaluation criteria in a JSON format based on the judge information.

7. The method according to claim 5, wherein the evaluating comprises evaluating the artistic element by evaluating movement of a dancer based on a feature keyword included in the judge information using an AI-based Multi Modal AI.

8. The method according to claim 5, wherein the evaluating comprises evaluating the technical element by determining similarity with evaluation criteria movement data using the at least one judge persona after extracting movement metadata from the dance video data.
